(19) United States
(12) Patent Application Publication
(10) Pub. No.: US 2025/0315895 A1
(43) Pub. Date: Oct. 9, 2025

(54) INTEGRATED CLAIMS PROCESSING HUB

(71) Applicant: Visa International Service Association, San Francisco, CA (US)

(72) Inventors: Libby A. Kurien, Santa Clara, CA (US); Denise R. Raper, Austin, TX (US); Ratna Deepthi Jarugu, Santa Clara, CA (US); Sonia Gupta, SAN FRANCISCO, CA (US)

(73) Assignee: Visa International Service Association, San Francisco, CA (US)

(21) Appl. No.: 19/098,347

(22) Filed: Apr. 2, 2025

Related U.S. Application Data
(60) Provisional application No. 63/573,855, filed on Apr. 3, 2024.
(60) Provisional application No. 63/573,753, filed on Apr. 3, 2024.

(51) Int. Cl. G06Q 40/08

(52) U.S. Cl. CPC G06Q 40/08

(57) ABSTRACT

A method is disclosed. The method includes receiving claim requests from a plurality of service provider computers associated with a plurality of service providers for fulfillment by a plurality of payors. Each claim request includes service provider information, payor information, and beneficiary information. The method also includes validating the claim requests, and determining for each service provider of the plurality of service providers, a net amount to be transferred to the service provider. The net amount is associated with a plurality of claim requests made by the service provider for different beneficiaries serviced by the service provider. The different beneficiaries may be associated with different payors. The method further includes facilitating for each of the service providers, a single funds transfer in the net amount to be transferred to the service provider.

### CROSS-REFERENCES TO RELATED APPLICATIONS

This application claims the benefit of the filing dates of U.S. Provisional Application No. 63/573,855, filed on Apr. 3, 2024, and U.S. Provisional Application No. 63/573,753, which are incorporated by reference herein in their entirety for all purposes.

### BACKGROUND

Current methods for processing healthcare claims do not enable real time estimates. Often, neither the member (e.g., patient) nor the payor (e.g., insurance company) knows the cost of a service upfront, and service providers (e.g., healthcare provider) do not receive daily payments. Moreover, service providers are responsible for collecting payments from members for services not covered by payors. The current ecosystem can comprise numerous middlemen in between providers and payors such as revenue cycle management companies, clearinghouses, and payment facilitators. These methods can be vulnerable to reconciliation challenges.

Further, the process for submitting claims and receiving payment for those claims requires the use of a significant number of messages and a significant amount of computational resources. For example, if a service provider services ten patients, the 10 claims need to be submitted to different payors, and 10 different payments can be received for those 10 claims. The complexity of this processing is amplified when taking into account that there can be thousands of service providers, thousands of patients, and hundreds of different types of payers interacting each other in today's healthcare system.

Embodiments of the disclosure address these and other problems individually and collectively.

### SUMMARY

One embodiment includes a method comprising receiving, by a processing hub, claim requests from a plurality of service provider computers associated with a plurality of service providers for fulfillment by a plurality of payors, each claim request including service provider information, payor information, and beneficiary information; validating, by the processing hub, the claim requests; determining, by the processing hub, for each service provider of the plurality of service providers, a net amount to be transferred to the service provider, the net amount associated with a plurality of claim requests made by the service provider for different beneficiaries serviced by the service provider, the different beneficiaries associated with different payors; and facilitating, by the processing hub, for each of the service providers, a single funds transfer in the net amount to be transferred to the service provider.

Another embodiment includes a claims processing hub configured to integrate a plurality of providers and a plurality of payors to process claims made by the plurality of providers to the plurality of payors, the claims processing hub comprising a processor; and a computer readable medium coupled to the processor, the computer readable medium comprising instructions for causing the processor to perform a method comprising receiving claim requests from a plurality of service provider computers associated with a plurality of service providers for fulfillment by a plurality of payors, each claim request including service provider information, payor information, and beneficiary information; validating the claim requests; determining for each service provider of the plurality of service providers, a net amount to be transferred to the service provider, the net amount associated with a plurality of claim requests made by the service provider for different beneficiaries serviced by the service provider, the different beneficiaries associated with different payors; and facilitating for each of the service providers, a single funds transfer in the net amount to be transferred to the service provider.

These and other embodiments are described in further detail below.

### BRIEF DESCRIPTION OF THE DRAWINGS

FIG. 1 shows a block diagram of a claims processing system according to some embodiments.

FIG. 2 shows a block diagram of a claims processing hub according to some embodiments.

FIG. 3 illustrates a flow diagram of a claims processing hub facilitating and validating eligibility messages according to some embodiments.

FIG. 4 illustrates a flow diagram of a method for processing a claim request.

FIG. 5 illustrates a block diagram of initial net position records for a claim request 500.

### DETAILED DESCRIPTION

Embodiments provide a claims processing hub enabling end to end daily net settlement between payors (e.g., insurance companies) and service providers (e.g., healthcare providers). The claims processing hub can net settle claims for payors and resource providers enrolled to the claims processing hub, and initiate payments with single funds transfers. Furthermore, the claims processing hub can provide a platform to facilitate messaging between payors and service providers, including real time eligibility checks, estimated amounts, and prior authorization and claims messaging. In some embodiments, the platform can utilize artificial intelligence for fraud management (e.g., unbundling claims), data cleansing, data verification (e.g., ICD/CPT codes), and message integrity.

When a service provider provides a service (e.g., a treatment) to a beneficiary (e.g., a patient), the service provider may submit a claim request to the claims processing hub for transmission to a payor. The claim request can include service provider information, payor information, and beneficiary information. The claims processing hub can verify that the beneficiary receives benefits from the payor (e.g., the patient is covered by the insurance company), and that the benefits include the service provided (e.g., the treatment is within plan). Additionally, the claims processing hub can verify message format and values provided in the request, and provide the request to the payor to make a claim adjudication.

The claims processing hub can receive claim requests from a plurality of service providers throughout a settlement window (e.g., one day). Records can be generated for each claim request comprising a service provider amount (e.g., an amount to be transferred to the service provider), a payor amount (e.g., an amount to be transferred by the payor), and optionally a claims processing hub amount, for each claim request. At the end of the settlement window, the processing hub can accumulate the records to determine net amounts.

A net amount can be determined for each of the service providers. For example, the net amount can be an accumulation of a amounts associated with plurality of claim requests made by the service provider for different patients serviced by the service provider. The different patients can be associated with different payors. For each of the service providers, the claims processing hub can facilitate a single funds transfer in the amount of the net amount to the service provider. Advantageously, the single funds transfer can replace multiple payments that might be made to the service provider, thereby saving computational resources, time, and messages that would be transmitted through data networks. For example, instead of sending one hundred payments for one hundred claims to a service provider, embodiments of the invention can send one payment for the one hundred claims.

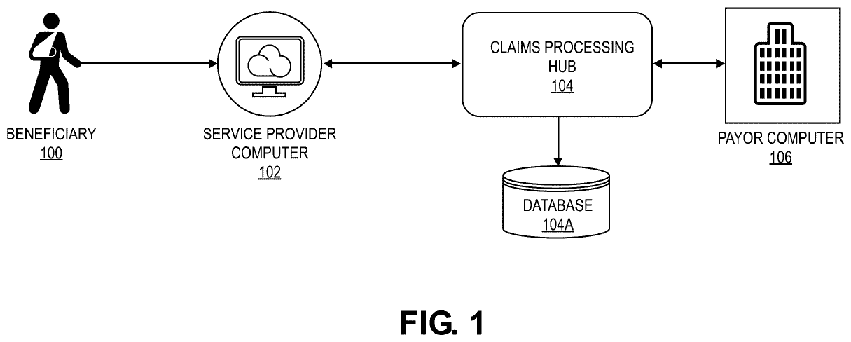

FIG. 1 shows a block diagram of a claims processing system 100 according to some embodiments. The system 100 includes a beneficiary 101, a service provider computer 102, a claims processing hub 104, and a payor computer 106 in operable communication with each other. The claims processing hub 104 can be in operable communication with the beneficiary 101, service provider computer 102, and payor computer 106 to facilitate claims messaging and payments. The claims processing hub 104 can store data and retrieve data from a database 104A.

The beneficiary 101 may receive a service from the service provider computer 102. For example, the beneficiary 100 may be a patient seeking a healthcare service, and the service provider 102 may be a healthcare provider. The payor computer 106 can provide coverage (e.g., healthcare insurance) on behalf of the beneficiary 100 for the service. Via the claims processing hub 104, the service provider computer 102 can transmit messages (e.g., eligibility check, estimated amounts, claim request, etc.) for the service to the payor computer 106, and the payor computer 106 respond.

Each of the entities in FIG. 1 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

For simplicity of illustration, a certain number of components are shown in FIG. 1. It should be understood, however, that embodiments of the present disclosure may include more than one of each component. In addition, some systems according to embodiments of the present disclosure may include a smaller number of components or a greater number of components than those shown in FIG. 1. For example, the claims processing hub 104 can facilitate messaging and payments for a plurality of service provider computers and a plurality of payor computers.

The payor computer 106 may provide a plan subscription to the beneficiary 101. The plan may include coverage for one or more services and may be compatible with one or more service providers. For example, the payor computer 106 may pay for a service on behalf of the beneficiary 101 if the service and service provider are included in the plan.

The service provider computer 102 may be operated by a service provider that provides services to the beneficiary 101. The service provider computer 102 can communicate with the claims processing hub 104 to review plan information to check if the beneficiary 101 is eligible for a service, or to obtain a list of included services. The service provider computer 102 can also transmit requests for pre-authorization, and estimated amounts (e.g., copay, amount covered by the plan). The service provider computer 102 can transmit a claim request to the payor computer 106 (via the claim processing hub 104) to request payment for the service.

The payor computer 106 and/or its associated payor can go through an onboarding process to register a profile with the claims processing hub 104 and can provide beneficiary plan information, copayment information, and deductible information to the claims processing hub 104 using APIs, messaging, and/or a batch upload process. Payor to contracted provider details and fee schedules, Tax IDs, NPI IDs, may also be collected by the claims processing hub 104. The payor computer 106 and/or its associated payor may be assigned a payor identifier to distinguish from other payor computers and payors that the service provider computer 102 and its associated service provider may interact with. The claims processing hub 104 can approve the payor and/or the payor computer 106 to the platform after performing an assessment of credit settlement risk and collecting treasury funds transfer and payment method information.

The service provider computer 102 and/or its associated service provider can go through an onboarding process and register a profile to an API developer platform of an online portal associated with the claims processing hub 104. The processing hub 104 can approve the service provider 102 to the platform after performing an assessment of credit settlement risk and collecting treasury funds transfer and payment method information. The service provider 102 and/or its associated service provider may be assigned a processing identifier (e.g., a service provider identifier) which may be stored by the claims processing hub 104. The claims processing hub 104 collect and verify service provider to payor details. For example, the claims processing hub 104 can collect and verify a list of payors 106 that each service provider 102 is contracted (e.g., in network) with. Such data may be stored as eligibility information which the claims processing hub 104 may use to verify coverage eligibility.

In various embodiments, the beneficiary 101 may operate a beneficiary user device which can enable communication with the claims processing hub 104. The beneficiary user device may be a mobile phone, for example. For example, during an enrollment process the beneficiary user device can transmit payor information, a credential, and other beneficiary information to the claims processing hub 104. The enrolled beneficiary 101 may then use the credential to verify coverage eligibility. The beneficiary user device may additionally enable the beneficiary 101 to review estimated costs for a service and provide a copay for the service.

The claims processing hub 104 may provide a number of services to facilitate the claims processing system. For example, the claims processing hub 104 may enroll service providers, payors, beneficiaries, etc. The claims processing hub 104 can provide identifiers to enrolled entities, route and store messages, validate messages, and manage payments.

The claims processing hub 104 can comprise a plurality of platforms for enabling claims messaging and payments. The platforms may be configured to provide automated onboarding and workflows, assignment of identifiers, API access for submitting claims, portal access for dashboards, reporting, manual claims and adjustments, analytics, identify fraud claims and assignments of risk score, rules as configured by payors, fraudulent claim reporting, payment instruction generation, invoice generation, etc.

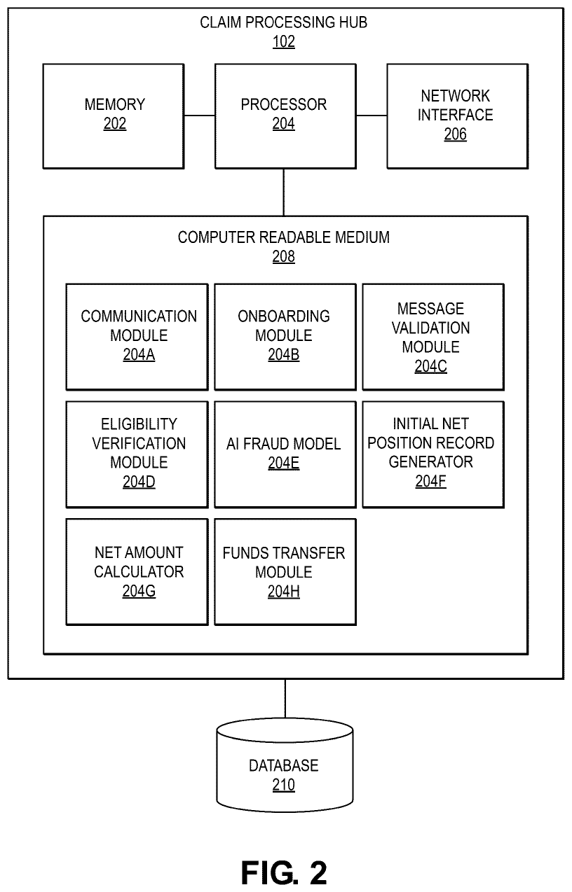

FIG. 2 shows a block diagram of a claims processing hub according to embodiments. The claims processing hub 200 comprises a processor 204, a memory 202, a network interface 206, a computer readable medium 208, and a database 209.

The memory 202 can be used to store data and code. The memory 202 may be coupled to the processor 204 internally or externally (e.g., cloud based data storage), and may comprise any combination of volatile and/or non-volatile memory, such as RAM, DRAM, ROM, flash, or any other suitable memory device. The memory 202 can store any suitable data described herein.

The network interface 206 may include an interface that can allow the claims processing hub 200 to communicate with external computers. The network interface 206 may enable the claims processing hub 200 to communicate data to and from another device (e.g., an authorizing entity computer, a resource provider computer, a service provider computer, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The computer readable medium 208 can comprise a number of modules including a communication module 208A, an onboarding module 208B, a message validation module 208C, an eligibility verification module 208D, an artificial intelligence (AI) fraud model 208E, an initial net position record generator 204F, a net amount calculator 204G, a funds transfer module 204H. The computer readable medium 208 may also comprise code, executable by the processor 204 for implemented a method comprising receiving claim requests from a plurality of service provider computers associated with a plurality of service providers for fulfillment by a plurality of payors, each claim request including service provider information, payor information, and beneficiary information; validating the claim requests; determining for each service provider of the plurality of service providers, a net amount to be transferred to the service provider, the net amount associated with a plurality of claim requests made by the service provider for different beneficiaries serviced by the service provider, the different beneficiaries associated with different payors; and facilitating for each of the service providers, a single funds transfer in the net amount to be transferred to the service provider.

The communication module 208A may comprise code that causes the processor 204 to generate messages, forward messages, reformat messages, and/or otherwise communicate with other entities.

The onboarding module 208B may comprise code that causes the processor 204 to enroll entities (e.g., payor computers, resource provider computers, beneficiaries) for interacting with the claims processing hub 200. For example, the onboarding module 208B may comprise logic that causes the processor 204 to receive enrollment information in a request from a resource provider computer to join the system, and store the enrollment information. The enrollment information may comprise eligibility information. The logic may include instructions for evaluating whether or not an entity can enroll. For example, the claims processing hub 200 can perform an assessment of credit settlement risk for payors and resource provider computers. The onboarding module 208B may additionally include instructions for generating and assigning identifiers for an enrolled entity.

The message validation module 204C may comprise code that causes the processor 204 to validate messages before a message is routed. For example, message validation module 204C may contain logic that causes the processor 204 to confirm correct messaging format and ICD/CPT (International Classification of Diseases/Current Procedural Terminology) codes are used.

The eligibility verification module 204D may comprise code that causes the processor 204 to verify coverage eligibility. For example, eligibility verification module 204D may contain logic that causes the processor 204 to check eligibility information to confirm that a beneficiary is covered by a payor, and that the payor is in network with a service provider.

The Al fraud risk module 204E may comprise code that causes the processor 204 to confirm that a message is authentic. For example, the Al fraud risk module 204E may contain logic that causes the processor 204 to perform an Al fraud risk assessment on the message or entity that sent the message. The Al fraud risk assessment can be performed using a neural network or any other suitable machine learning algorithm.

The initial net position record generator 204F may comprise code that causes the processor 204 to generate initial net position records for claim requests. For example, the initial net position record generator 204F may contain logic that causes the processor 204 to create balancing records and determine claim amounts, fees, and charges.

The net amount calculator 204G may comprise code that causes the processor 204 to determine net amounts. For example, the net amount calculator may contain logic that causes the processor 204 to accumulate claims and claim amounts to determine a net amount.

The funds transfer module 204H may comprise code that causes the processor 204 to facilitate single funds transfers. For example, the funds transfer module 204H may contain logic to generate and transmit messages to a payment hub. The messages may contain instructions to transfer funds in net amounts to or from accounts. The accounts may be service provider and payor accounts.

The database 210 can store data accessible by the processor 204. Such data may include data that relates to the facilitation of messaging and payments being performed. For example, payor and provider identifiers, eligibility information, claim messages, and records may be stored in the database 210. Eligibility information can comprise payor to contracted provider details, settlement schedules, etc. The database 210 may be a conventional, fault tolerant, relational, scalable, secure database such as Oracle or Sybase. Data in the database 210 may be updated, as necessary.

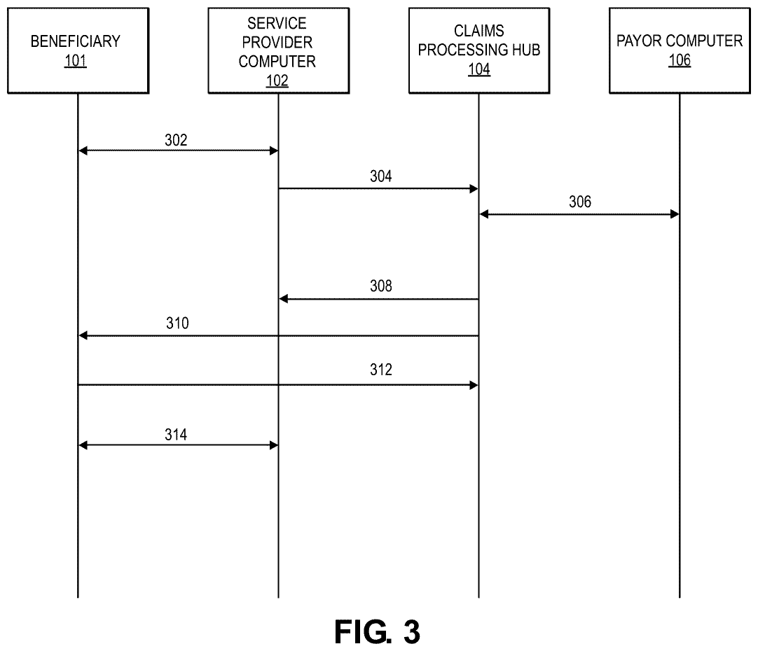

FIG. 3 illustrates a flow diagram of a claims processing hub facilitating and validating eligibility messages according to some embodiments. FIG. 3 shows a claims processing system comprising a beneficiary 101, a service provider computer 102, a claims processing hub 104, and a payor computer 106. The claims processing system may exchange eligibility messages to verify coverage and coverage amounts for one or more services before a service is provided.

Eligibility messages may include a coverage eligibility check, predetermination, and/or preauthorization. Messaging may include FHIR (Fast Healthcare Interoperability Resources) standard API (Application Programming Interface) messages, and may be facilitated and verified via the claims processing hub 104.

Prior to step 302, the beneficiary 101 may enroll with the claims processing hub 104. The beneficiary 101 can provide a payment credential, beneficiary information, and payor information during enrollment with the claims processing hub 104. The claims processing hub 104 can store the enrollment information in a profile for the beneficiary 101, such that upon receiving an eligibility request comprising the payment credential, the claims processing hub 104 can resolve the beneficiary information and payor information and determine coverage and coverage amounts in real time.

At step 302, the beneficiary 101 can visit a service provider to receive a service. However, before the service is provided, the service provider may wish to verify the beneficiary 101 receives coverage from payor computer 106 and check the benefits of the coverage. The service provider can request beneficiary information and payor information from the beneficiary 101. The beneficiary 101 can provide the information to the service provider computer 102 for verification.

In some embodiments, the beneficiary 101 may use a beneficiary user device and transmit the payment credential to the service provider computer 102. For example, using a digital wallet application on the beneficiary user device, the beneficiary 101 may tap the beneficiary user device to the service provider computer 102 (e.g., a service provider computer system including a POS or point of sale terminal), transmitting the credential over NFC (near field communications).

At step 304, the service provider computer 102 can submit an eligibility request message to the claims processing hub 104 comprising the payment credential. The eligibility request message may be a coverage eligibility check (e.g., the FHIR “CoverageEligibilityRequest” resource), a predetermination (e.g., a FHIR “Claim” with a predetermination parameter), or a preauthorization (e.g., a FHIR “Claim” with a predetermination parameter).

To determine whether the beneficiary 101 is covered by a plan from the payor computer 106, whether the plan is currently valid, or requesting plan information or preauthorization requirements (e.g., preauthorization required, preauthorization not required), the service provider computer 102 may submit an eligibility request. An eligibility response may include an indication of whether the plan is currently valid, and optionally plan information and/or preauthorization requirements.

While exploring one or more service options for the beneficiary 101, and estimated amounts of coverage for the one or more service options are desired, the service provider computer 102 may submit a predetermination request comprising the one or more service options. A predetermination response may comprise estimated amounts of coverage for the one or more services and copay amounts.

When proposing one or more services to provide the beneficiary 101, the service provider computer 102 may submit a preauthorization request comprising the one or more proposed services. A preauthorization response may comprise a preauthorization adjudication (e.g., approval, denial, partial approval). If successful, preauthorization may additionally reserve the estimated coverage amount.

At step 306, when the service provider 102 submits a request to the claims processing hub 104, the claims processing hub 104 can validate the message format and values provided in the request submitted by the service provider 102. The claims processing hub 104 may also verify that the service provider 102 has up to date information. Requests may be assigned with unique transaction identifiers and response codes for tracking purposes.

Once the information is validated, the claims processing hub 104 can validate that a contract exists between the service provider 102 and the payor computer 106. The claims processing hub 104 can use the payment credential to resolve the associated beneficiary information and payor information. For example, the claims processing hub 104 can look up the payment credential in the database 104A to obtain profile data of the beneficiary 101. The claims processing hub 104 can evaluate the resolved beneficiary and payor information to verify that the payor computer 106 is in network with the service provider computer 102, and the beneficiary 101 is subscribed to a plan from the payor computer 106.

The claims processing hub 104 can also ensure that the codes used in the claim (ICD, CPT) are correct and valid. As an advantage, the claims processing hub 104 can use artificial intelligence to detect incorrect codes. In some embodiments, the claims processing hub 104 may use rules based processing to determine incorrect codes. For example, the claims processing hub 104 can validate the codes used in the claim against payor configured rules.

The claims processing hub 104 may route the eligibility request to the payor computer 106 to obtain an eligibility response. For example, the claims processing hub 104 can provide the eligibility request to the payor computer 106. The payor computer 106 can determine a response, and provide it to the claims processing hub 104. Optionally, the claims processing hub 104 may determine an eligibility response based on stored data in the database 104A. For example, the claims processing hub 104 can check eligibility information in the database 104A received during enrollment to determine coverage eligibility.

At step 308, the claims processing hub 104 can provide the service provider computer 102 with an eligibility response message. The claims processing hub 104 can validate and store the eligibility response before providing it to the resource provider computer 102. Optionally, the service provider may continue to explore service options, repeating steps 304-308 as desired.

The eligibility response message may be a coverage eligibility response, a predetermination response, or a preauthorization response corresponding to the request received in step 306. The eligibility response message can comprise beneficiary information, payor information, an indication of whether or not coverage is valid, and if applicable, the estimated amount of coverage. The eligibility response message may additionally comprise a copay amount (e.g., amount of coverage to be provided by the beneficiary 101).

At step 310, if coverage is verified, the claims processing hub 104 can transmit the copay amount to the beneficiary user device (via the claims processing application), and prompt the user to confirm payment. The claims processing hub 104 may additionally notify the service provider computer 102 of the copay amount, and notify the payor computer 104 of the estimated amount of coverage.

At step 312, the beneficiary 101 can confirm the copay via their beneficiary user device, and the beneficiary user device can notify the claims processing hub 104 of the confirmed payment. The beneficiary 101 need not provide the credential since it was already provided in step 302. The claims processing hub 104 may initiate a transaction to debit the credential for the copay amount. For example, the claims processing hub 104 can generate an authorization request message comprising the credential and the copay amount, and transmit it to an authorizing entity computer (not shown) for authorization.

Advantageously, in embodiments of the invention, the credential associated with the beneficiary 101 and the user device storing the credential (e.g., a primary account number such as a credit or debit card number) can be used in place of a typical payor identification device such as an insurance card. The credential can be used by the service provider to both determine whether the beneficiary 101 is covered under a plan (e.g., an insurance plan) managed by the payor, and pay for any fees that would be owed by the beneficiary. As such, the number of devices that a beneficiary 101 needs to have in their possession and the number of interactions that they need to conduct is reduced as compared to conventional methods, thereby providing a technical advantage over such conventional methods.

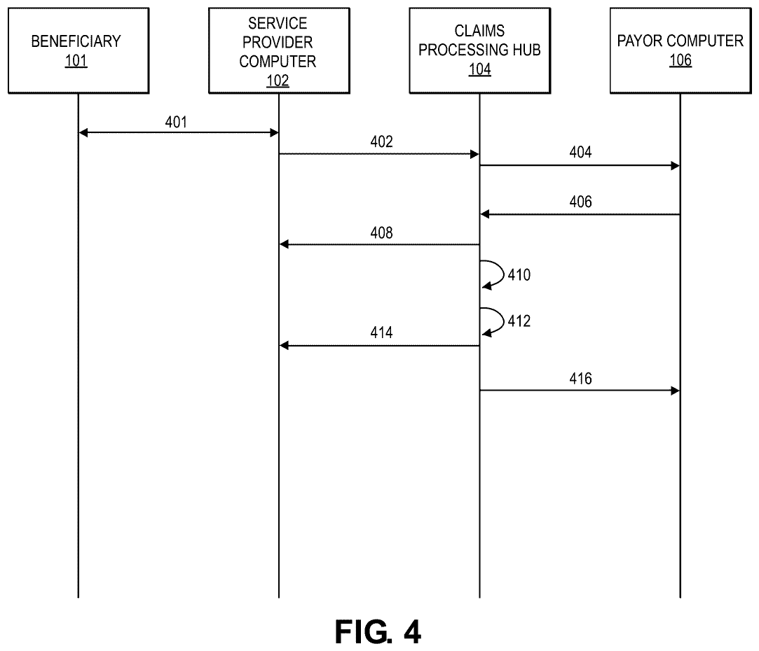

At step 314, after an eligibility response confirming the beneficiary 101 has coverage for a selected service is received, the selected service may be provided. For example, the service provider can provide treatment (e.g., medical or dental treatment) to the beneficiary 101. The service provider may then file a claim request for the service and the service provider computer 102 can submit a claim request for claim adjudication. This method is described below with reference to FIG. 4.

FIG. 4 illustrates a flow diagram of a method for processing a claim request. The claim request may be to request coverage from a payor computer 106 after a service has been provided to a beneficiary 101. The claim request may be facilitated, validated, and recorded by a claims processing hub 104.

At step 401, the service provider computer 102 may obtain beneficiary information and payor information from the beneficiary 101. The service provider computer 102 may request a credential from the beneficiary 101 and use the credential to obtain beneficiary information and payor information from the claims processing hub 104 (e.g., as illustrated by FIG. 3), or any suitable method.

At step 402, a service provider can access a claims processing platform via the service provider computer 102 to file a claim request to the claims processing hub 104. The claim request may be filed after a service is provided to the beneficiary 101. The service provider computer 102 can transmit the claim request comprising beneficiary information, service provider information, payor information, and the provided service to the claims processing hub 104 via an API. In some embodiments, the claim can be a manual claim or adjustment.

At step 404, the claims processing hub 104 can validate the claim request, and route it to the payor computer 106 for claim adjudication. Al fraud checks may be performed to detect unbundling claims and verify that the claim request is not a duplicate. The claims processing hub 104 can check transaction identifiers of the claim request and compare it to stored data (e.g., claim requests) in database 104A to verify that it is not a duplicate.

At step 406, the payor computer 106 can review the claim request and determine an amount of coverage to provide for the claim request. The payor computer 106 can transmit a claim response to the claims processing hub 104 comprising a claim adjudication decision (e.g., whether the claim is denied, approved, partially approved, or still pending) and the amount of coverage to be provided.

At step 408, the claims processing hub 104 can verify the claim response, store it for analytics and billing in database 104A (in FIG. 1), and route it to the service provider computer 102.

At step 410, after the claim has reached adjudication, the claims processing hub 104 may calculate initial net position records to be accumulated for settlement. The claims processing hub 104 can compute fees based on timeliness, data quality, and create initial net position accumulator records for payors and providers comprising the claim amount, fees between the payor and provider, and fees to the claims processing hub 104.

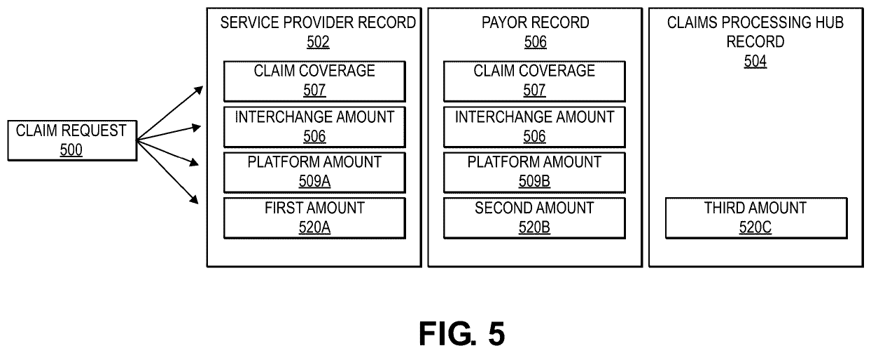

FIG. 5 illustrates a diagram of initial net position records for a claim request 500. The initial net position records may include a service provider record 502 comprising a first amount 520A to be transferred to the service provider operating the service provider computer, a payor record 506 comprising a second amount 520B to be transferred from the payor associated with the payor computer, and a claims processing hub record 504 comprising a third amount 520C to be provided to a hub entity that operates the claims processing hub.

The first amount 520A to be transferred to the service provider may be calculated based upon the amount of claim coverage 507 approved by the payor in the claim adjudication, an interchange amount 506, and a platform amount 509A. For example, for a given claim, the service provider may be credited the amount of coverage 507, and may be debited an interchange amount 506 and a platform amount 509A.

The second amount 520B to be transferred by the payor may be calculated based upon the amount of claim coverage 507, the interchange amount 506, and the platform amount 509B. For example, for the claim, the payor may be credited the interchange amount 506, and debited the amount of claim coverage 507 and the platform amount 509B.

The interchange amount 506 may be credited to the payor to incentivize payor participation despite being required to provide daily funds (or on other settlement basis). The platform amounts 509A and 509B may be debited to the service provider and the payor in exchange for the services provided by the claims processing hub. The third amount 520C may comprise the platform amounts 509A and 509B.

As an illustration, the claim coverage 507 may be $1000, the interachange amount 506 may be $10, the platform amount 509A and 509B may be $20. The service provider can be credited $1000 for the claim coverage 507, debited $10 for the interchange amount 506, and debited $20 for the platform amount 509A, such that the first amount 520A to be transferred to the service provider may be $970. The payor can be credited $10 for the interchange amount 506, debited $1000 for the claim coverage 507, and debited $20 for the platform amount 509B such that the second amount 520B to be transferred by the payor is $1010. The claims processing hub can be credited $20 for the platform amount 509A and $20 for the platform amount 509B, and the third amount 520C may be $40.

Referring back to the method of FIG. 4, steps 402-410 may be repeated throughout the settlement window for a plurality of claims. For example, the service provider can file a plurality of claims after providing services to different beneficiaries associated with different payors. The claims processing hub 104 may receive the plurality of claims from the service provider computer 102, and each claim may be validated and routed to a respective payor computer. Additionally, for each claim, the claims processing hub 104 can generate initial net position records.

At step 412, the claims processing hub 104 can determine a net amount to be transferred to the service provider computer 102. The claims processing hub 104 can consolidate the plurality claims made by the service provider computer 102 and the associated service provider initial net position records (e.g., 502 in FIG. 5). The net amount may be a sum of the first amounts of the initial net position records. The claims processing hub 104 can accumulate the first amount from each of the initial net position records to determine the net amount to be transferred to the service provider of the service provider computer 102.

Additionally, in step 412 the claims processing hub 104 may determine a payor net amount to be transferred by the payor computer 106. At the end of the settlement window, the claims processing hub 104 can consolidate a plurality of claims made by different service providers for different beneficiaries covered by the payor computer 106 and accumulate the second amount (e.g., 520B in FIG. 5) to be transferred by the payor computer.

At step 414, the claims processing hub 104 can initiate a single funds transfer in the net amount to the service provider computer 102. For example, the claims processing hub 104 can post the net settlement amounts to a general ledger, and provide an instruction to a payment hub (not shown) to transfer funds in the net amount to the service provider computer 102.

At step 416, the claims processing hub 104 can further initiate a single funds transfer in the payor net amount.

The payment hub can receive instructions from the claims processing hub 104 to transfer predetermined amounts of funds from the payor to the payment hub, and a predetermined amount of funds from the payment hub to the service provider. This process can be repeated for each of the payors for their payments to various service providers, and each of the service providers that are being paid by various payors. Instead of handling multiple payment requests, a payer only needs to send one payment to the payment hub for the predetermined period, and the service provider only needs to receive one payment for the predetermined period. Payments can be made via any suitable method including ACH (automated clearing house), wire funds transfers, etc.

In the above illustrated example, the claims processing hub 104 determines a net amount to be transferred to the service provider computer 102. While one service provider computer 102 and one payor computer 106 is shown in this example for clarity, the claims processing hub 104 can repeat steps 512-514 for a plurality of service provider computers and payor computers. Net amounts to be transferred to each service provider and payor net amounts to be transferred each payor can be calculated for the plurality of service provider computers and payor computers. Daily single funds transfers may be facilitated for each service provider computer and each payor computer.

Embodiments of the invention provide a number of advantages. Embodiments can reduce the delays in claims processing with real time eligibility, estimated amounts, prior authorization, and claims messaging verification. Embodiments can simplify payments between payors and providers with daily net settlement techniques and associated payment reporting. Embodiments can be integrated within existing systems or a healthcare specific instance of the system. Embodiments of the invention can also significantly reduce the number of messages and payments that would be required in conventional systems, thereby saving computational resources and network bandwidth.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a processing hub, claim requests from a plurality of service provider computers associated with a plurality of service providers for fulfillment by a plurality of payors, each claim request including service provider information, payor information, and beneficiary information;
validating, by the processing hub, the claim requests;
determining, by the processing hub, for each service provider of the plurality of service providers, a net amount to be transferred to the service provider, the net amount associated with a plurality of claim requests made by the service provider for different beneficiaries serviced by the service provider, the different beneficiaries associated with different payors; and
facilitating, by the processing hub, for each of the service providers, a single funds transfer in the net amount to be transferred to the service provider.

2. The method of claim 1, wherein the service providers are healthcare providers and the payors are insurance companies.

3. The method of claim 1, wherein the method occurs at least once per day.

4. The method of claim 1, wherein facilitating the single funds transfer for each of the service providers comprises providing an instruction to a payment hub to transfer funds in net amounts to the service provider computers.

5. The method of claim 1, further comprising:
determining, by the processing hub, for each payor of the plurality of payors, a payor net amount to be transferred by the payor, the payor net amount associated with a plurality of claim requests made by different service providers for different beneficiaries serviced by the different service providers, the different beneficiaries associated with the payor; and
facilitating, by the processing hub, for each of the payors, a single funds transfer in the payor net amount to be transferred by the payor.

6. The method of claim 1, wherein each claim request comprises a claim amount, and wherein the method further comprises generating, for each claim request, a service provider record and a payor record based on the claim amount, wherein the service provider record comprises a first amount to be transferred to a service provider and the payor record comprises a second amount to be transferred from a payor.

7. The method of claim 6, wherein the net amount to be transferred to the service provider is based on a sum of first amounts determined for the plurality of claim requests made by the service provider.

8. The method of claim 1, wherein validating the claim requests comprises using artificial intelligence to check each claim request for fraud.

9. The method of claim 1, wherein the claim requests are FHIR API messages.

10. The method of claim 1, wherein the beneficiary information comprises a payment credential.

11. The method of claim 1, wherein prior to receiving the claim requests the method comprises receiving, by the processing hub, eligibility information relating the plurality of service providers to the plurality of payors, and wherein the validating the claim requests comprises determining, for each claim request, service provider information, payor information, and beneficiary information are related based on the eligibility information.

12. A claims processing hub configured to integrate a plurality of providers and a plurality of payors to process claims made by a plurality of service providers to the plurality of payors, the claims processing hub comprising:
a processor; and
a computer readable medium coupled to the processor, the computer readable medium comprising instructions for causing the processor to perform a method comprising:
receiving claim requests from a plurality of service provider computers associated with the plurality of service providers for fulfillment by the plurality of payors, each claim request including service provider information, payor information, and beneficiary information;
validating the claim requests;
determining for each service provider of the plurality of service providers, a net amount to be transferred to the service provider, the net amount associated with a plurality of claim requests made by the service provider for different beneficiaries serviced by the service provider, the different beneficiaries associated with different payors; and
facilitating for each of the service providers, a single funds transfer in the net amount to be transferred to the service provider.

13. The claims processing hub of claim 12, the method further comprising:
determining, for each payor of the plurality of payors, a payor net amount to be transferred by the payor, the payor net amount associated with a plurality of claim requests made by different service providers for different beneficiaries serviced by the different service providers, the different beneficiaries associated with the payor; and
facilitating, by the processing hub, for each of the payors, a single funds transfer in the payor net amount to be transferred by the payor.

14. The claims processing hub of claim 13, wherein facilitating the single funds transfer for each of the plurality of payors comprises providing an instruction to a payment hub to transfer funds in payor net amounts from payor computers.

15. The claims processing hub of claim 13, wherein each claim request comprises a claim amount, and wherein the method further comprises generating, for each claim request, a service provider record and a payor record based on the claim amount, wherein the service provider record comprises a first amount to be transferred to a service provider, and wherein the payor record comprises a second amount to be transferred by the payor.

16. The claims processing hub of claim 12, wherein the service providers are healthcare providers and the payors are insurance companies.

17. The claims processing hub of claim 12, wherein the claim requests are FHIR API messages.

18. The claims processing hub of claim 12, wherein the beneficiary information comprises a payment credential.

19. The claims processing hub of claim 12, wherein the method occurs at least once per day.

20. The claims processing hub of claim 12, wherein validating the claim requests comprises using artificial intelligence to check each claim request for fraud.
